(19) United States
(12) Patent Application Publication
(10) Pub. No.: US 2007/0118515 A1
(43) Pub. Date: May 24, 2007

(54) System and method for matching expertise

(76) Inventor: Peter J. Dehlinger, Palo Alto, CA (US)

Correspondence Address: PERKINS COIE LLP, P.O. BOX 2168, MENLO PARK, CA, 94026, US

(21) Appl. No.: 11/650,108

(22) Filed: Jan. 5, 2007

Related U.S. Application Data
(63) Continuation-in-part of application No. 11/321,369, filed on Dec. 28, 2005.
(60) Provisional application No. 60/640,740, filed on Dec. 30, 2004.
(60) Provisional application No. 60/665,724, filed on Mar. 25, 2005.

(51) Int. Cl. G06F 17/30

(52) U.S. Cl. 707/3

(57) ABSTRACT

Disclosed are a method, machine-readable code, and a database for use in identifying, among a group of professionals, one or more professionals having expertise with a given problem or specialty of interest. In the method, a search query related to the given problem is used to identify a summary statement taken from a library of citation-rich documents. The identified statement is linked to a patent-class tag associated with the statement in a citation-rich document, and the identified tag is linked to one or more members of a group of professionals whose own writings contain that citation tag.

This application is a continuation-in-part of U.S. patent application Ser. No. 11/321,369 filed Dec. 28, 2005, which claims priority to U.S. Provisional Patent Application Nos. 60/640,740 filed Dec. 30, 2004 and 60/665,724 filed Mar. 25, 2005, all of which are incorporated herein by reference in their entirety.

### FIELD OF THE INVENTION

The present invention relates to a method and machine readable code for identifying professionals having expertise with a given problem or specialty of interest, such as a legal or health-care specialty.

### BACKGROUND OF THE INVENTION

The internet has made it easier for prospective clients, patients or others looking for professional expertise to identify practitioners having legal, medical or other expertise in a given area or with respect to a given problem. For example, a corporation or individual seeking legal advice in a certain area of law can search for law firms that have specialists in the legal area of interest, then further navigate within selected law-firm websites to identify individual practitioners who are experienced in that area of law. Similarly, one can search the internet to identify hospitals or clinics that specialize in certain areas of health care, then visit the individual hospital or clinic websites to try to identify individual physicians, dentists, veterinarians, or other health-care providers who appear to have desired qualifications and experience in the area of concern.

These internet search tools augment the more traditional ways of locating competent service professionals, such as referrals from friends or colleagues, or yellow-page listings. However, like the more traditional means, they tend to be somewhat random, in that there is rarely a good filter for discriminating among scores or hundreds of practitioners in a given locale. Also like the more traditional methods, they may have a strong marketing bias, in that web postings may be more promotional than informative.

There is thus a need for a website tool that offers prospective clients or patients a more direct and reliable method for identifying professionals with expertise in a given area of law or health care.

### SUMMARY OF THE INVENTION

In one aspect, the method includes a computer-assisted method for identifying, among a group of professionals, such as legal or health-care professionals having expertise with a given problem or specialty of interest. The method includes the steps of:

(a) processing a user-input query composed of word, and optionally, word-group terms that describe or are descriptive of the given problem or specialty for which expertise is being sought,

(b) accessing a database containing a word record of summary statements, which statements include holdings, principles, conclusions, or definitions taken from a library of citation-rich documents in the field of the professional, to identify one or more summary statements having high term matches with the user-input query,

(c) accessing a database containing citation tags linked to the summary statements, where the tags represent citations associated with the summary statements in citation-rich documents, to identify one or more one or more tags linked to the statement(s) identified in step (b),

(d) accessing a database containing group-member identifiers linked to citation tags, through citation tags taken from citation-rich documents prepared by members of the group of professionals, to identify one or more group members linked to the one or more tags identified in step (c), and

(e) presenting the group-member identifier(s) identified in step (c) to the user.

The processing in step (a) may include constructing a search vector composed of non-generic word, and optionally, word-group terms, and term-value coefficients assigned to each term, and the accessing step (b) may be effective to identify summary statements having the top match score with the search vector.

The method may further include, as part of step (b), presenting identified summary statements to the user, and having the user select those statements which best represent the given problem or specialty for which expertise is being sought.

The citation-rich documents prepared by members of the group of professionals, and from which are extracted citation tags that link members of the group to specific tags, and the library of citation-rich documents from which the summary statements and associated tags are extracted, may be substantially different sets of citation-rich documents, or substantially overlapping sets of documents.

For use in identifying one or more legal professionals having expertise with a given legal problem of interest, the citations tags linked to group-member identifiers may be taken from citation-rich documents, such as jaw-journal articles and court briefs, authored by one or more group members, and the summary statements and associated tags may be taken from a library that includes appellate court decisions.

For use in identifying one or more medical professionals having expertise with a given medical problem of interest, the citation tags linked to group-member identifiers may be taken from citation-rich documents, such as medical journal articles, authored by one or more group members, and the summary statements and associated tags may be taken from a library of citation-rich documents, such as a more general library of medical journal articles.

The identifier of each group member may include the member's name, specialty, locale, and organization type and name, the user input query may include constraints on one or more of member specialty, locale, and organization type and name, and step (d) may be carried out to identify at least one group-member tag that also matches the user-input constraints.

The database accessed in each of steps (b)-(c) may be part of a single relational database. The database accessed in step (c) may include a matrix whose matrix values represent, for each pair of citation tags, a co-occurrence value related to the document co-occurrence of the two tags of the pair in the citation-rich documents from which the tags were taken, and step (c) may include accessing the database to identify one or more one or more tags linked directly to the statement(s) identified in step (b), or linked indirectly to the statement(s) identified in (b) through an above-threshold co-occurrence linkage to a tag directly linked to such statement(s).

In another aspect, the invention includes machine-readable code which is operable on a computer to execute machine-readable instructions for performing the above method steps for use in identifying, among a group of professionals, one or more professionals having expertise with a given problem or specialty of interest.

In still another aspect, there is provided a relational database for use in identifying, among a group of professionals, one or more professionals having expertise with a given problem or specialty of interest. The database comprises database tables containing:

(i) a word record of summary statements, including holdings, principles, conclusions, or definitions contained in a library of citation-rich documents in the field of the professional,

(ii) citation tags linked to the summary statements, where the tags represent citations associated with said statements in citation-rich documents, and

(iii) group-member identifiers linked to citation tags, through citation tags taken from citation-rich documents prepared by members of the group of professionals.

These and other objects and features of the invention will become more fully apparent when the following detailed description of the invention is read in conjunction with the accompanying drawings.

### BRIEF DESCRIPTION OF THE DRAWINGS

FIG. 1 shows hardware and software components of the system of the invention;

FIG. 2A shows, in summary diagram form, the processing of citation-rich documents to form tag-ID, statement-ID, and statement word index tables and a tag co-occurrence matrix in an embodiment of the invention;

FIG. 2B shows in summary diagram form, the processing of group citation-rich documents to form group-ID and specialty-ID tables in an embodiment of the invention;

FIG. 3 illustrates a tagged statement extracted from a citation-rich document;

FIGS. 4A-4F show representative table entries in a statement-ID table for citation-rich documents (4A), a statements word index table (4B), a tag-ID table (4C), a tag co-occurrence matrix (4D), a group-ID table (4E), and a specialty-ID table (4F);

FIGS. 5A and 5B show in flow diagram form, operations in processing citation-rich documents to form a statement-ID table and tag-ID table in the database of the invention (5A), and in assigning tag IDs (5B);

FIG. 6 is a flow diagram of steps used in generating a word index of statements table;

FIG. 7 is a flow diagram of steps used in generating a co-occurrence matrix;

FIG. 8 is a flow diagram shows steps in the construction of a group-ID table in an embodiment of the invention;

FIG. 9 shows a user interface for the method of the invention;

FIG. 10 is a flow diagram of operations carried for displaying specialty-related information to a user;

FIG. 11 is a flow diagram of steps used in identifying top-ranked tags for a given user-input statement in the method of the invention; and

FIG. 12 is a flow diagram of steps for retrieving and displaying group names to the user.

### DETAILED DESCRIPTION OF THE INVENTION

A. Definitions

A “citation-rich document” is a document containing at least one and typically a plurality of cited references or citations, and associated statements. For example, a reported court case typically contains many cited cases, where each cited case (citation) is associated with a holding or summary of that case, usually a statement that precedes the case citation. Similarly, many types of legal documents prepared by lawyers, such as opinions, briefs, and legal memos, will contain a plurality of cited cases, along with the case holdings or summaries. A scientific or scholarly article will likewise contain a plurality of cited references, typically in footnote/bibliographic form, each citation typically being preceded by or included within a statement that summarizes the idea or conclusion of the cited reference.

A “statement” or “summary statement” refers to a summary of a holding or conclusion associated with a cited reference, or citation. The statement, as it occurs in a citation-rich document, is typically a complete sentence, and is followed by or includes a bibliographic citation, which may be a footnote or author citation or case-name citation to a bibliographic listing of cited references or cases, or may be the actual citation itself.

A “search query” or “query statement” or “user-input query” refers to a single sentence or sentence fragment or fragments or list of words and/or word groups that describe or are descriptive of the given problem or specialty for which expertise is being sought.

A “verb-root” word is a word or statement that has a verb root. Thus, the word “light” or “lights” (the noun), “light” (the adjective), “lightly” (the adverb) and various forms of “light” (the verb), such as light, lighted, lighting, lit, lights, to light, has been lighted, etc., are all verb-root words with the same verb root form “light,” where the verb root form selected is typically the present-tense singular (infinitive) form of the verb.

“Generic words” refers to words in a natural-language passage that are not descriptive of, or only non-specifically descriptive of, the subject matter of the passage. Examples include prepositions, conjunctions, pronouns, as well as certain nouns, verbs, adverbs, and adjectives that occur frequently in passages from many different fields. “Non-generic words” are those words in a passage remaining after generic words are removed.

A “document identifier” or “DID” identifies a particular digitally encoded or processed document in a database, in particular, a citation-rich document.

A “statement identifier” or “SID” identifies a particular summary statement, in particular, a statement extracted from a citation-rich document and associated with one or more citations. Typically, each statement extracted from a citation-rich document is assigned a separate identifier, so that identical statements extracted from different documents are assigned different SIDs, although they may have the same citation identifier or tag.

A “tag identifier” or “citation identifier” or “TID” identifies a particular tag, e.g., case cite or bibliographic reference extracted from a citation-rich document. In the case of tags from citation-rich documents, a tag identifier may be associated with one or more, and often several, different statement identifiers.

A “database” refers to a database of records or tables containing information about documents and/or other document- or citation-related information. A database typically includes two or more tables, each containing locators by which information in one table can be used to access information in another table or tables.

A “tagged statement” refers to a statement extracted from a citation-rich document and its associated citation or tag.

B. System Components

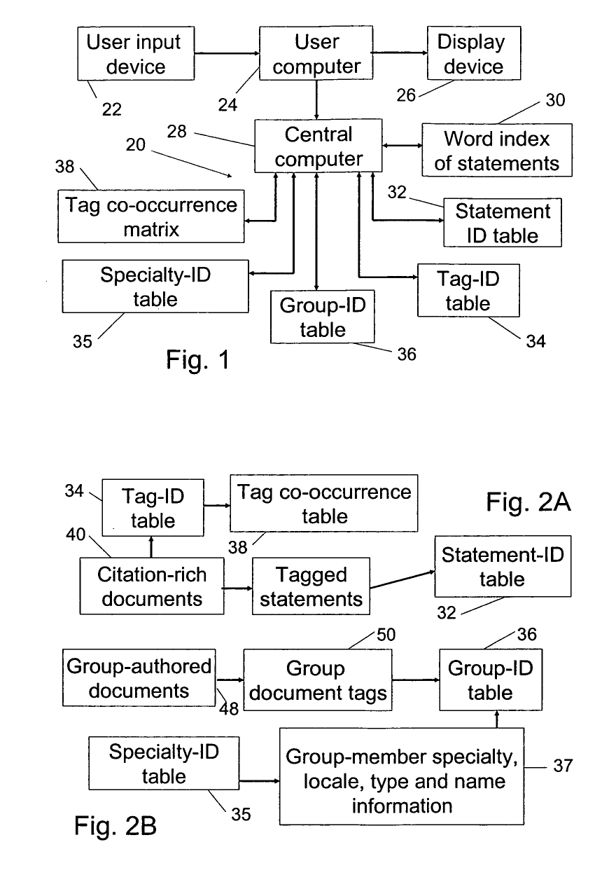

FIG. 1 shows the basic components of a system 20 for use in identifying, among a group of professionals, one or more professionals having expertise with a given problem or specialty of interest, such as a legal, health-care or technical expertise.

A computer or processor 24 in the system may be a personal computer or a central computer or server that communicates with a user's personal computer. The computer has an input device 22, such as a keyboard, by which the user can enter a query or other information, as will be described below. A display or monitor 26 displays the interface and program operation states and output. One exemplary interface is described below with respect to FIG. 9. Computer 24 in the system is typically one of many user terminal computers, each of which communicates with a central server or processor 28 on which the main program activity in the system takes place.

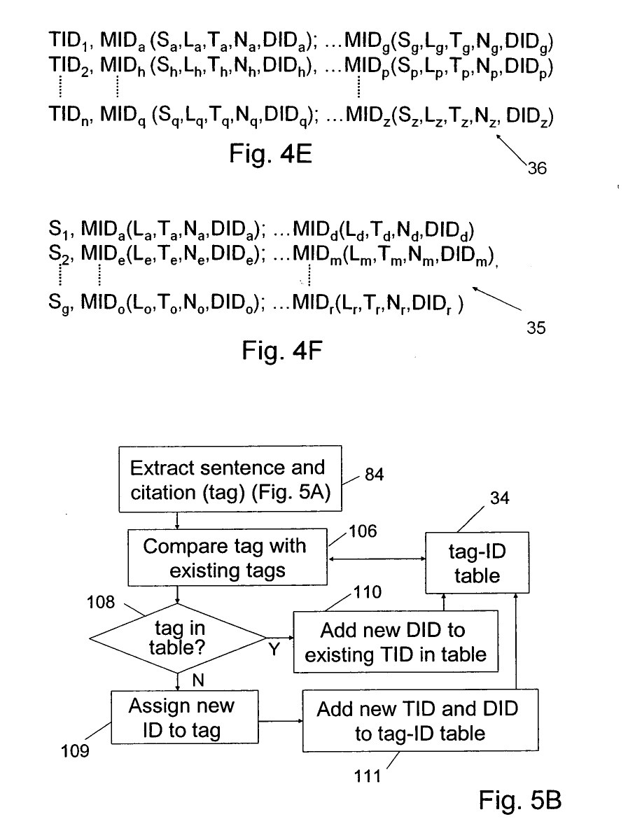

A database in the system, typically run on processor or server 28, includes in one embodiment a word-index of statements table 30, a statement-ID table 32, a tag-ID table 34, a group-ID table 36, and a specialty-ID table 35, all of which will be described below, e.g., with reference to FIGS. 4A-4C and 4E and 4F. The database may also include a co-occurrence matrix 38 described below with reference to FIG. 4D and FIG. 7. The database also includes a database tool that operates on the server to access and act on information contained in the database tables, in accordance with the program steps described below. One exemplary database tool is MySQL database tool, which can be accessed at www.mysql.com.

It will be appreciated that the assignment of various stored documents, databases, database tools and search modules, to be detailed below, to a user computer or a central server or central processing station is made on the basis of computer storage capacity and speed of operations, but may be modified without altering the basic functions and operations to be described.

C. Basic Database Tables and Data Relationships

FIG. 2A is a flow diagram of the high-level steps used in processing citation-rich documents to produce lists of statements and associated tags (tagged statements) that are processed, as described below, to form tag-ID table 34, which in turn is used in forming tag-co-occurrence matrix 38, and statement-ID table 32, which in turn is used in forming word index of statement table 30.

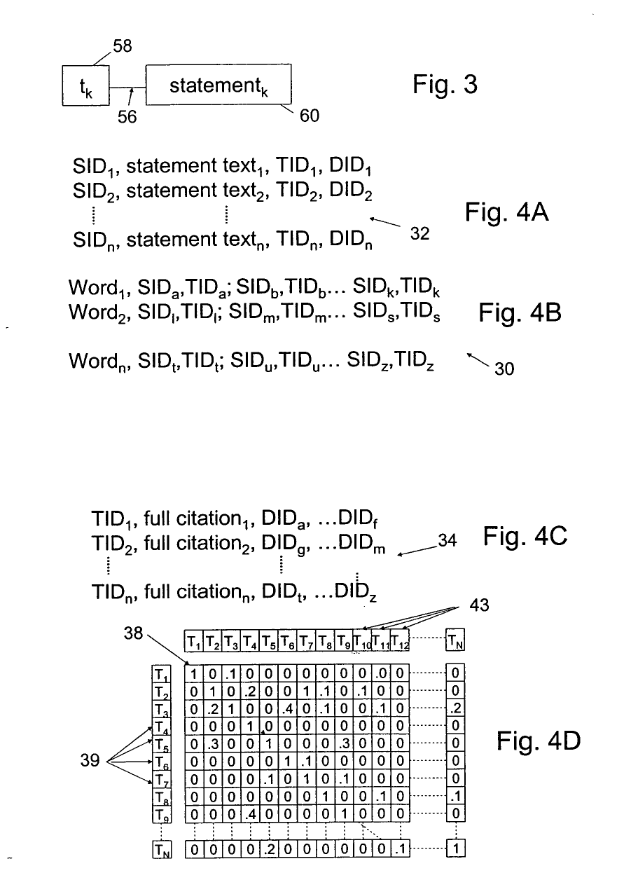

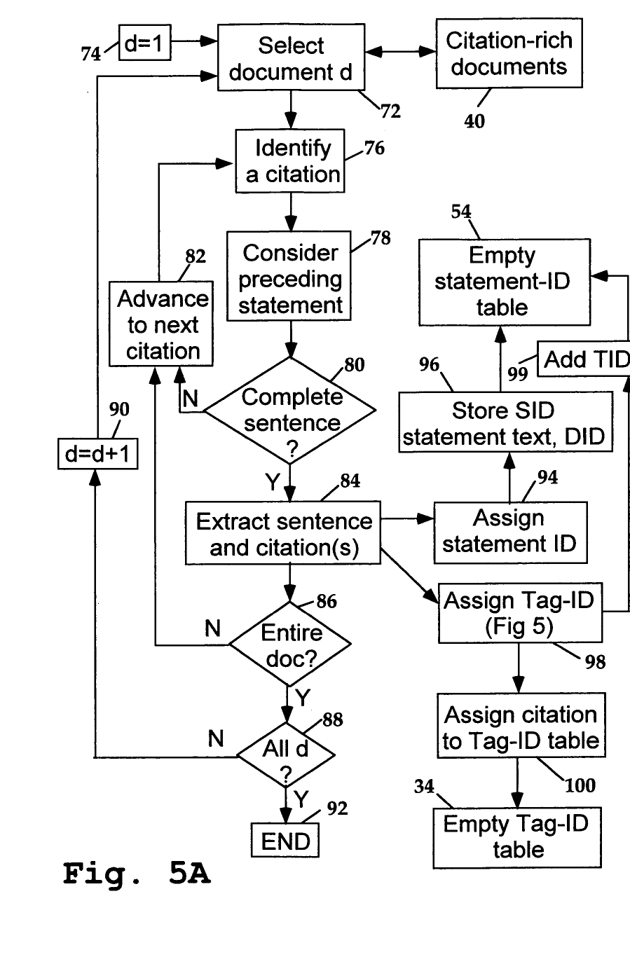

FIG. 3 shows a tagged statement 56 extracted from a citation-rich document, and consists of a bibliographic or case-law citation tag 58 (tₖ), and a summary statement (statementₖ) 60 associated with that tag in the citation-rich document. Methods for processing citation-rich documents to extract tagged statements will be considered below in FIGS. 5A and 5B.

The library of citation-rich documents from which this type of tagged statement is taken is represented at 40 in FIG. 2A. Collectively, the citation-rich documents includes a library of documents that may contain up to several hundred to several hundred thousand of more documents, such as a large collection of scientific or scholarly publications, reported legal cases, e.g., appellate cases, all of which contain multiple citations or cites, e.g., references to other cases or other articles or scholarly works. One exemplary library of citation-rich documents used for creating a “legal” database are reported appellate decisions, e.g., from both federal and state appellate courts. An exemplary library of citation-rich documents used for creating a “medical” or “technical” database are articles from biomedical or technical journals or periodicals.

The program described in FIGS. 5A and 5B operates to extract the citations (or cites) from each document, and the typically one summary statement (also referred to herein as a “holding” or “summary” or “proposition”) that the cite “stands for” in that particular document, yielding a plurality of tagged statements 42. Each statement extracted from a document (and associated with one or more citation tags) is placed in statement-ID table 32, which has as its key locator, a statement identifier (SIDᵢ), where each statement has a separate identifier. Identical statements from different documents are assigned different statement identifiers, and the program need not attempt to consolidate identical or near-identical statements into a single statement.

FIG. 4A shows typically entries for table 32, and includes for each SIDᵢ locator, the text of the extracted statement, a tag (citation) identifier (TIDⱼ) that identifies the citation associated with that statement (the citation identifier is determined as described below with reference to FIG. 5B), and a document identifier (DIDᵢ) that identifies the document from which the statement and associated tag are extracted. Typically a document will contain several TIDs, and the same TID in different documents may be associated with several different statements. The statements associated with any given TID may be identical, similar in wording and/or content, or different in content, indicating that the particular TID “stands for” more than one holding or proposition. In addition to the table information indicated, the statement-ID table may include, for each statement, the full text of a document passage, e.g., paragraph, containing that statement.

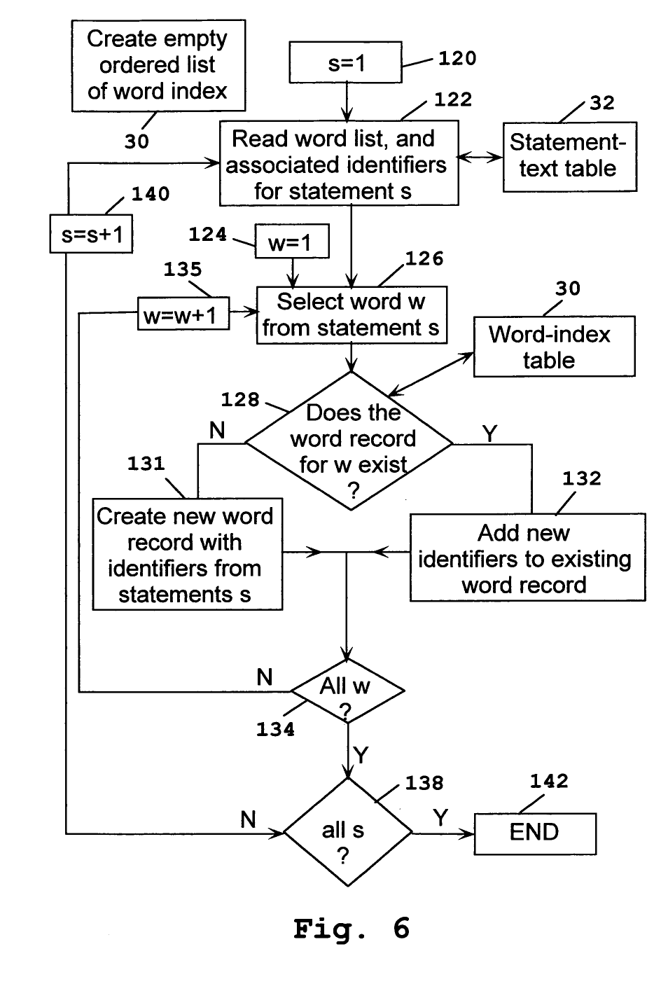

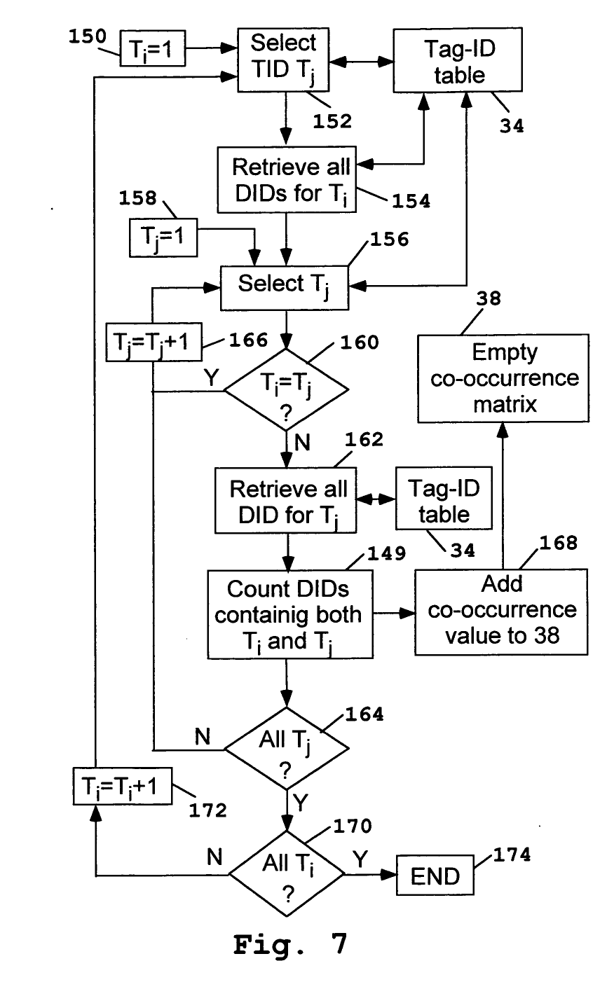

The statements in the statement-ID table are processed, in accordance with the method described below with respect to FIG. 6, to form the word index of statements table 30. The key locator for the word-index table is a statement word, such as Wordᵢ shown in FIG. 4C, and for each word, there is a list of all SIDs containing that word, and for each statement SID, the TID associated with that statement. Most words in the table will contain a relatively long list of statements and associated TIDs. Preferably, the words in the table do not include generic words, such as common pronouns, conjunctions, prepositions, etc., and may also exclude as certain generic words that are common to a large number of statements, such as (in the legal field) “legal,” “law,” “standard,” “test,” “court,” and the like, and (in the scientific field), such words as “study,” “experiment,” “finding,” “results,” “conclusion,” and “data,” and the like. The TID associated with each SID in the word-records table is determined according to the method in FIG. 5B.

Also as shown in FIG. 2A the citations from the citation-rich documents are assembled into tag-ID table 34 which has the table information shown in FIG. 4C. The locator in this table is a tag ID (TIDᵢ), and each row in the table includes the full citation for that TID, for example, a listing of the author, title, journal name, volume, page number and year for a journal article, or case name, reporter name, volume, and page number, and court and year information, volume for a legal citation, and discussed further below, and the document identifiers (DIDs) from which the tags are derived.

With continued reference to FIG. 2A, tag-ID table 34 is used in creating the tag co-occurrence matrix 38. The co-occurrence matrix, a portion of which is shown below in FIG. 4D, is an N×N matrix of N row tags, such as Tᵢ, Tⱼ, and Tₖ, times N column tags, such as tags T₁, T₂, T₃, and T_{w}, where the value of each matrix entry for a TᵢTⱼ matrix pair is the number of times the two tags (citations) Tᵢ and Tⱼ appear in the same document. The sum of the values in each row may be normalized to a common value, e.g., such that the sum of all matrix values in a given row is 1. The matrix is formed in accordance with the method described with respect to FIG. 7.

The database tables just described form the database of statements and tags used in the method for associating a user-statement query, representing the given problem or specialty for which expertise is being sought, to one of more tags, representing an identifiable tag (citation) identifier associated with the statement. The database tables now to be described with reference to FIG. 2B are used in connecting these one or more identified tags to a professional with a given professional skill or area of expertise.

With reference to FIG. 2B, group-ID table shown at 36 is generated from a collection of group-authored citation-rich documents 48 which are processed to yield a list of group-document tags 50. A portion of a group-ID table is shown in FIG. 4E. As seen, the table associates each of a list of tags TIDᵢ, with group member identifiers MIDᵢ, representing one or more professionals in a group that have authored a citation-rich document or patent containing that tag.

For the legal field, the tags in table 36 represent citations that have been extracted from legal documents, such as briefs, memos, and opinions, or law-journal articles or notes authored or co-authored by a given legal professional, where the cites are extracted from the documents as described below. For the medical field, the tags represent citations that have been extracted from medical, biomedical, dental, animal-science or other citation-rich journal articles or books authored or co-authored by a given health-care professional, such an a physician, dentist, veterinarian, nurse, or other health-care professional, where the cites are extracted from the documents as described below.

In one general embodiment, the group-authored, citation-rich documents is the same group of documents used in constructing the tag-ID, statement-ID, and word-index of statement tables discussed with respect to the FIG. 2A. In this case, each tag identifier TIDᵢ in table 36 will correspond to one of the tags in tag-ID table 34. More typically, the citation-rich documents used in constructing the group-ID table is a more limited set of documents (only those authored or co-authored by a group member in the database) than that used in constructing table 34, so that table 34 may contain many more tag identifiers than table 36. One advantage of employing a more comprehensive library of documents for constructing tables 32, 30, and 34 is that many of the cites will each have appeared in several different documents, and thus be associated with multiple different statements. This, in turn, will allow for more robust searching statement searching, in the initial search for pertinent citations (tags).

With continued reference to FIG. 4E, each group-member MIDᵢ associated with a tag in table 36 contains information about that member's professional specialty (Sᵢ), locale or location or primary business (Lᵢ), type of institution the member is affiliated with (Tᵢ), such as “law firm with less than 25 lawyers,” “law firm with over 100 lawyers,” “clinic,” “hospital” and the like, the name and contact information (Nᵢ) of that institution, and the one or more documents DID authored by the group member from which expertise-related tags are extracted. This information is supplied by the individual group members and may be collected in a table or spreadsheet 37 in FIG. 2B. Note that each tag row in the table contains the identity (MID) and member information of all group members that are associated with a given tag.

The group-member information contained in table 36 or from table 37 is reformatted for searching by professional specialty in the specialty-ID table 35 illustrated in FIG. 4G. The specialties IDs (Sᵢ in the table) are recognized specialties within the legal, medical, or other professional fields, such as, in the legal field, corporate finance, business litigation, and so forth, and in the medical field, such specialties such cardiologist, endocrinologist, oncologist, neurologist, and so forth. These specialties are identified by the individual group members, as noted above. As seen in the table, each specialty contains the name IDs (MIDᵢ) for all group members with that specialty, the member's locale and type and name of institution, and source documents, as above.

D. Processing Documents and Constructing the Word-Index and Co-Occurrence Tables

FIG. 5A is a flow diagram of steps employed by the system in extracting citations and associated statements from each of a plurality of citation-rich documents 40. For purposes of illustration, documents 40 are legal documents, either opinions briefs or other documents generated by lawyers, or case-law decisions, e.g., appellate decisions published by court reporters. It will be appreciated from the following description how the system can be modified for extracting citations and statements from other types of citation-rich documents, such as scientific or other scholarly works, or any other type of documents in which statements in the document are supported by reference citations. In particular, it is noted that in most citation-rich legal documents, the citation is often given in full within the body of the document, whereas in many other types of citation-rich documents, the full citation is given as a footnote or in a bibliographic list of references at the end of the document.

The total number of documents to be processed may be quite large, e.g., up to several hundred thousand citation-rich documents or more. Each document, as it is selected at 72 (with the counter initialized at 1 for the first document, at 74) is assigned a new, next-up document ID, which will follow the document through the construction of the database tables.

For purposes of specific illustration, it is assumed that the document being processed is a patent-validity opinion, and that the particular passages the program first encounters are those Paragraphs 1-4 below, which will be used to illustrate the operation of the system in extracting citations and their corresponding statements:
[Paragraph 1] The presumption of validity of patent claims, like all legal presumptions, is a procedural device, not substantive law. However, it does require the decision maker to employ a decisional approach that starts with acceptance of the patent claims as valid and that looks to the challenger for proof of the contrary. Accordingly, the party asserting invalidity has not only the procedural burden of proceeding first and establishing a prima facie case, but the burden of persuasion on the merits remains with that party until final decision. TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).
[Paragraph 2] The challenging party's burden also includes overcoming deference to the PTO's findings and decisions in prosecuting the patent application. Deference to the PTO is due “when no prior art other than that which was considered by the PTO examiner is relied on by the attacker.” American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984). Conversely, no such deference is due when the party challenging the patent raises prior art or evidence that was not considered by the PTO in its decision and evaluation of the patent application:
[Paragraph 3] When an attacker simply goes over the same ground traveled by the PTO, part of the burden is to show that the PTO was wrong in its decision to grant the patent. When new evidence touching validity of the patent not considered by the PTO is relied on, the tribunal considering it is not faced with having to disagree with the PTO or with deferring to its judgment or with taking its expertise into account. American Hoist, at 1360.
[Paragraph 4] The description must clearly allow persons of ordinary skill in the art to recognize that the inventor invented what is claimed.” Thus, an applicant complies with the written description requirement “by describing the invention, with all its claimed limitations, not that which makes it obvious,” and by using “such descriptive means as words, structures, figures, diagrams, formulas, etc., that set forth the claimed invention.” Lockwood, supra.

The first step in the document processing is to identify a citation, at 76. This is done, in the case of legal citations, by the program looking for certain words, abbreviations, and indicia that are common to legal citations. For example, the program might look for one of the following cues characteristic of a legal case name: “In re,” “ex parte,” or “v.” In addition, the program might look for the abbreviation for a state or federal reporter, such as “F.2d,” “F.Supp,” or “SCt,” or “USPQ”, all of which can be entered into a relatively small library of case reporters at the state and/or federal level. If a reporter name is found, the program could confirm by looking for numbers on either side of the reporter abbreviation. Finally, the case citation is likely to include the name of the trial or appellate court which handed down the decision, and the program can further confirm a citation by identifying a court abbreviation, such as “SCt,” “NDCa,” “Fed. Cir.”, and so forth, followed by a year, e.g., “1999,”, “2004.” indicating the year that the decision was published.

A similar approach for identifying citations would apply, for example, to citation-rich scientific or technical publications, where the citation would be identified on the basis of one or more of (i) a standard abbreviation for each of a plurality of journals that are likely to be encountered (stored in a small dictionary); (ii) standard journal identifier information, such as volume, page and date, and (iii) a list of authors, last name, followed by an initial, and usually at the beginning of the citation. It is recognized that the citations in many scientific, technical, and law-journal articles are contained in an end-of document bibliography which is referred to within the text either by a reference number, typically in parentheses or brackets, or by first author name, which thus provides a cue to find the full citation as a footnote or in a bibliography at the end of the document.

In the example given above, the two citations in Paragraph 1 can each be identified by (i) a case name containing a “v.” (ii) the names of court reporters “F.2d” and “USPQ2d,”, (iii) a number preceding and following each court reporter, and (iv) a court name abbreviation and year of publication (typically in parentheses). The end of the first cite and beginning of the second one can be identified by one or all of (i) a semi-colon at the end of the first cite; (ii) the court name abbreviation and year at the end of the first cite, and (iii) a new case name at the beginning of the second cite.

TP Laboratories, Inc. v. Professional Positioners, Inc., 724 F.2d 965, 971, 220 USPQ 577, 582 (Fed. Cir. 1984); Richdel, Inc. v. Sunspool Corp., 714 F.2d 1573, 1579, 219 USPQ 8 (Fed. Cir. 1983).

Similarly, the sole cite in Paragraph 2 is identified by (i) a case name containing a “v.” (ii) the name of a court reporter “F.2d”, (iii) a number preceding and following each court reporter, and (iv) a court name abbreviation and year of publication (typically in parentheses. In addition, the subsequent appeals history of the case may follow the initial cite, this being distinguished from a separate citation by one or more of (i) lack of a semi-colon, (ii) lack of a new case name, and (iii) an abbreviation of the disposition of the appeal, e.g., “cert denied.” As above, the latter abbreviation is included in a “case-citation” abbreviations library that the program accesses during the operation of locating citations. “American Hoist & Derrick Co. v. Sowa & Sons, 725 F.2d 1350, 1359 (Fed. Cir.), cert. denied, 469 U.S. 821, 83 L. Ed. 2d41, 205 S. Ct. 95 (1984).

It is common in a citation-rich document for reference to be made to a previously-referenced citation, and in this case, the citation may include simply a name in the case name followed by a comma the abbreviation of “supra,” meaning “above,” or “higher up” (in the document), “infra,” meaning “below” (in the document) or “ibid,” meaning “in the same passage or citation,” or alternatively, a name in the case, followed by a comma, and the word “at” followed by a page number, referring to the page in the citation at which the referenced statement is found.

For example in Paragraph 3, the citation to “American Hoist, at 1360” is recognized by (i) a name in a case name already cited in the document, and (ii) “at” followed by a number. Similarly, the citation in the Paragraph 4 “Lockwood, supra” is identified by (i) a name in a case name already cited in the document, and (ii) a comma followed by the word “supra.” Of course, identifying previously cited references in any document requires that the program keep a list of cited case names during the processing of each documents, so that these can be compared with case-name abbreviations when one of the indicia of a previously cited case is encountered. Once a citation is encountered, it is extracted and placed in a file where the citation will be assigned a TID, as described below with respect to FIG. 5B.

As shown at 78 in FIG. 5A, the program then considers the sentence that immediately precedes the citation. If the sentence is a complete sentence, i.e., begins with a capital letter and ends with a period or semi-colon or with a parentheses which give the citation, the sentence is extracted and assigned to the “statement” for the citation or citations that it precedes, as a 84. Thus, for example, in Paragraph 1, the complete sentence that precedes each of the two citations is:

Accordingly, the party asserting invalidity has not only the procedural burden of proceeding first and establishing a prima facie case, but the burden of persuasion on the merits remains with that party until final decision.

Similarly, the sentence that precedes the single citation in Paragraph 2 is: Deference to the PTO is due “when no prior art other than that which was considered by the PTO examiner is relied on by the attacker.”

This preceding sentence is the statement or holding (or one of the statements or holdings) that will be assigned to the associated citation for the particular document from which the statements is extracted. As indicated at 84 in the figure, the sentence (statement) is extracted, assigned a statement ID number at 94 (each statement is assigned a new, next-up number) and the statement text is then stored, along with the SID and DID, at 96. Once the TID has been identified, as described below with respect to FIG. 5B, and indicated at 98 in FIG. 5A, the statement SID, text, TID, and DID are added to table 323 in constructing the statements-ID table in the system.

If, during the processing of text that precedes a citation, an incomplete sentence is encountered, e.g., because a citation occurs in the middle of the statement, the partial sentence back to the beginning of the sentence may be used as the citation statement, or the entire statement may be omitted, by advancing to the next citation without processing the tag associated with an incomplete sentence, as indicated. If the statement contains two or more citations, each citation is assigned to the entire statement. In some case, the case name will precede the associated statement. This format can be recognized typically by the words “In” or “according to” or “as stated in” (name of case), followed by the associated statement.

The TID, once assigned, is also added, at 100, as the key locator to a empty (or growing) tag-ID table 34, along with the associated SID and DID.

This processing is continued, through the logic of 86 and 82, until all citations in a document and associated statements have been identified, and all SIDs, associated statement texts, TID s, associated citations, DID, and other identifying information has been placed in the appropriate tables. Each document is similarly processed through the logic of 88, 90, until all of the citation-rich documents in 40 have been so processed.

FIG. 5B is a flow diagram of the operation of the program in assigning new TIDs to each newly-extracted citation. Illustrating the procedure for legal citation-rich documents, after extracting a new citation and its statement, at 84, and as described above, the new tag is compared at 106 with existing tags in tag-ID table 34. This comparing entails comparing each name in the new citation with each name in each of the existing cites in table 34, as indicated at 108. If a name match is found in any citation, the program compares the reporter information between the new and searched citation. If a reporter-information match is found, at 108, e.g., identical reporter and adjacent numbers, the two citation tags are considered identical. In this case, the just-extracted tag is assigned the number of the already-assigned tag, at 110, and that tag number is assigned to the various database tables. In particular, and as shown in the figure, the document ID from which the citation was extracted is added to the list of existing DIDs for that assigned TID in the tag-ID-table. If the newly-extracted tag is not already in the tag-ID table, from the comparison at 108, the tag is assigned a new number, at 109, and placed as a new citation entry in the citation-ID table, at 111, and also added to the other database tables.

The types and variations of statements extracted from citation-rich documents can be seen in the Example below, where a tagged-statement database was constructed from tagged statements extracted from about 1,000 published appellate decisions in the field of patent law. In general, many and often most of the statements associated with a given citation tend to be similar in meaning, particularly where the number of documents containing a citation is relatively small, e.g., less than 10. However, with citations that are found in a large number of documents, e.g., 20-50 or more, a fairly wide variation in the content of the statements can be expected.

Where the tagged statements in a citation-rich document are footnotes, the program notes each footnote, accesses the footnote information, and asks: Is the footnote a reference citation? This question is answered, as above, by checking for citation information, such as known journal abbreviations, and/or other standard citation indicia, such as volume, page, date, and author indicia. If the footnote is confirmed as a citation, the sentence associated with the footnote is stored as a citation, and given the assigned citation.

Alternatively, the citation format may be a parenthetical entry containing an author name or names, typically followed by the year of publication. In this format, when a single or small number of names in parenthesis is found, the program checks the bibliography at the end of the document, and looks for that name among the listed authors, which typically appears as at the beginning of the citation. If a citation is found, the sentence associated with that citation is then stored as a tagged statement.

Where other citation formats are used, one simply modifies the tagged-statement extraction program so that (i) each occurrence (notation) of a citation is noted, (ii) the program retrieves the actual citation from the document, and (iii) that citation is associated with the associated statement in the document.

As will be seen below, the general methods for extracting and tabulating citation tags from citation-rich documents can be employed in extracting citation tags from group-authored citation rich documents, and for tabulating the tags in a group-ID table of the type described above.

As noted above, the program uses non-generic words contained in the statements stored in the statement-ID tables the statement texts to generate a word-records or word index of statements table 30. This table is essentially a dictionary of non-generic words, where each word has associated with it, each SID containing that word, and optionally, for each SID, the corresponding TID for that statement, as described above.

To form the word-records or word index of statements table, and with reference to FIG. 6, the program creates an empty ordered list 30, and initializes the SID to s=1, at 120. The program now retrieves SID, from the statement-ID table 32, and stores a list of non-generic words in the statement, and also reads in the associated identifiers for that statement, at 122. With the word number initialized at 1, the program selects the first word w in statement s, and asks, at 128, is word w already in the word index table. If it is, the word record identifiers (associated SID and TID) for word w are added to word-index table 30 for that word in the table, at 132. If not, a new word entry is created in table 30, at 131, along with the associated SID and TID identifiers. This process is repeated, through the logic of 134, 135, until all of the non-generic words in statement s have been added to the table. Once a statement has been processed, the program advances, through the logic of 138, 140, until all statements in the statement-text table have been processed and added to the word-records table, terminating the processing steps at 142.

In one exemplary embodiment, every verb-root word in a statement is converted to its verb root; that is, all verb-root variants of a verb-root word are converted to a common verb-root word.

The system also may include one or more “citation affinity” matrices used in various system operations to be described below. As used herein, “citation affinity matrix” refers to an N×N matrix of N citations, where each matrix value tag i×tag j indicates the affinity of tags (citations) i and j in documents from which the N citations are extracted. This section considers, as an exemplary affinity matrix, a co-occurrence matrix 38 whose matrix values are the normalized number of document co-occurrences of each pair of citations in citation-rich documents.

FIG. 7 is a flow diagram of steps employed in the system for generating co-occurrence matrix 38. As noted above, this is an N×N matrix of all N tags, where each i×j term in the matrix is the number occurrence of all documents in the system (e.g., citation-rich documents) that contain both TIDᵢ and TIDⱼ, where the matrix values may be normalized to 1, that is, the matrix values may be adjusted so that the sum of all of the matrix values for a given citation in a matrix row is one. To construct the matrix, Tᵢ is initialized to i=1, at 150, and the program selects at 152 tag T₁ from the tag-ID table 34, and retrieves all of the DIDs for that TID, at 154. A second tag count at 158 is set at j=1 for tags Tⱼ, and a second tag Tⱼ is selected from table 34. If Tⱼ is the same as Tᵢ, the program advances to the next Tⱼ, through the logic of 166, and a zero is placed at the Tᵢ×Tᵢ matrix position (on the matrix diagonal). If Tᵢ and Tⱼ are different cites, the program retrieves all documents for Tⱼ, at 162, from tag-ID table 34, and then counts the number of documents (DIDs) that contain both Tᵢ and Tⱼ. This “co-occurrence” value is added, at 168, to matrix 38.

This process is repeated, through the logic of 164, 166 until all Tᵢ×Tⱼ co-occurrence values have been determined for the selected tag Tᵢ. The program now proceeds to the next tag Tᵢ₊₁, through the logic of 170, 172, until the matrix values for all W citations have been determined, at 174. The matrix values for each matrix row may now be normalized to a sum of 1, as indicated above.

E. Generatinq a Group-ID Table

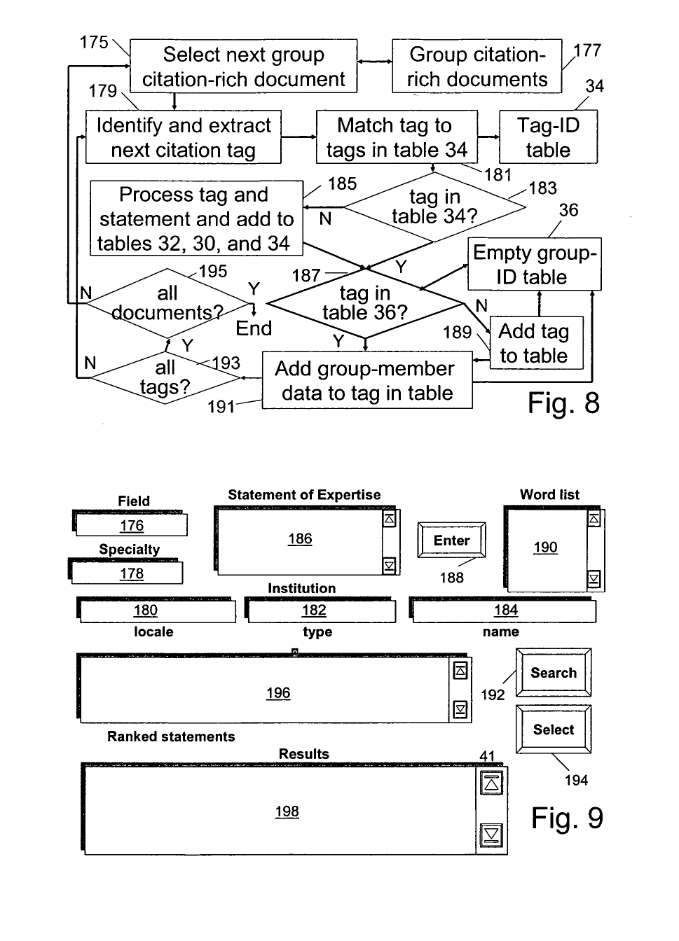

FIG. 8 illustrates, in flow-diagram form, steps in generating group-ID table 36 whose table entries are discussed above with respect to FIG. 4F. The group citation-rich documents indicated at 177 are citation-rich documents authored by members of the group of professionals who constitute the target of the search in the system. As noted above, the group documents are typically legal briefs, opinions, memos and/or law-journal articles for professionals in the legal field, scientific or other biomedical journal articles in the health-care field, and technical or scholarly journal articles for a variety of other professionals, such as economist and engineers.

Initially the program selects at 175 a first group-citation document from the documents 177, and this document is processed at 179, essentially as described above with respect to FIG. 5A, to extract the first citation tag (but not the accompanying statement). The extracted tag is then compared, at 181, with existing tags in tag-ID table 34, to determine if the extracted group-member tag matches any of the tags previously harvested in the group of citation-rich documents 40. This tag matching is carried out as described with reference to FIG. 5B. If the newly extracted tag is not found in table 34, at 183, the system will further process the document, at 185, to extract the accompanying statement and assign a new tag-ID, as described above with respect to FIGS. 5A and 5B, and the newly extracted statement and identified tag will be added to statement-ID table 32, word-index of statements 30, and tag-ID table 34, ensuring that every tagged statement in the group-member documents is also included in the statement and tag search tables 30, 32, and 34.

Following this tagged statement processing step at 185, the program will assign the newly extracted tag a new TID, or if the newly-extracted tag matches a tag in table 34, the program assigns the newly-extracted tag the same tag-ID number as in table 34, then matches the newly extracted tag with the tags already placed in an empty group-ID table 36. If no tag match is found, at 187, the new TID is added to the group-ID table at 189. If a tag match is found, or after adding the new tad-ID to table 36, the program then adds group-member data to that tag, at 191, linking the tag-ID with data for the group-member who authored the document from which the tag was extracted. As noted above, this group-member data may include, for each group member, the member's professional specialty, locale, and institution type and name, as well as the document DID from which the tag is taken.

This document processing is repeated, through the logic of 193, until each tag in the selected group member document has been extracted, assigned a tag-ID number, and placed in table 36 along with the same group-member data. The document processing is repeated, through the logic of 195, until all group-member documents have been processed.

F. User Interface and Initial Group-Member Data Selection

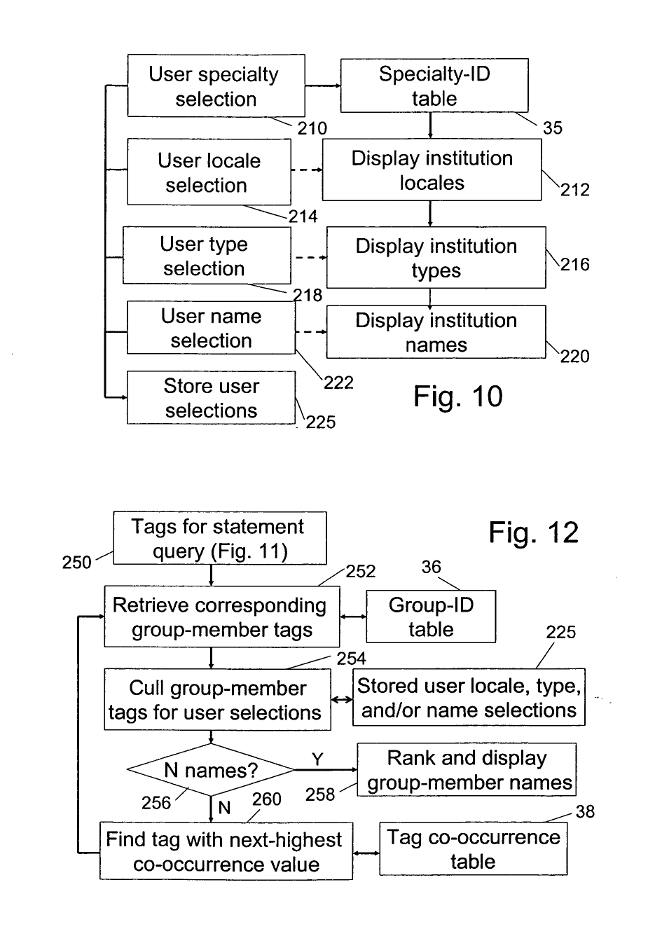

FIG. 9 shows a graphical interface in the system of the invention. The interface includes a number of input boxes which will be used to help the user in constraining the search to specified specialties, locales, or types or names of affiliated institutions. For example “Field” box 176 is a drop-down menu from which the user can select a general professional field, such as lawyer, physician, dentist, veterinarian, and so forth. Once the user has made a field selection, and with reference to FIG. 10, the program will consult a “field” table (not shown) which contains a list of specialties represented in the specialty-ID table 35 described above, and these various specialties will then be available for display in a drop-down menu 178 and indicated by “Specialty” in FIG. 9. For example, if the field selected is medicine, the drop-down menu would display the usual medical specialties, such as internal medicine, cardiology, surgical oncology, and so forth.

At this point, the program will use the specialty-ID table 35 to constrain the user choices in the search for a professional, as illustrated by the flow diagram in FIG. 9. As seen here, after the user makes a specialty selection at 210, the program consults table 35 to find all group members having that identified specialty. Once these are found, the program identifies all of the locales, e.g., cities or areas, associated with those group members, and these locales are displayed, e.g., alphabetically, in the “Locale” drop-down menu box at 180 in FIG. 9. Following a user selection of one or more locales, at 214 in FIG. 10, the program identifies the types of institutions associated with the group members having the selected specialty and locale, and displays this to the user at 216 in FIG. 10, in the drop-down “Type” menu at 182 in FIG. 9. As noted above, “Type” of institution may be size of institution, e.g., small, medium-sized or large law firm, hospital or clinic, research institution, and so forth. After a user selection for institution type, at 218 in FIG. 10, the program will find all affiliate institutions for the group members having the selected specialty, locale and institution type, institutions type, and display the institution names at 220 in FIG. 10, and in the drop-down menu box at 184 in FIG. 9. After user selection of institution name(s), at 225 in FIG. 10, the program stores the user selections. Optionally, the program may at this point display, in box 198 of the interface, the names and information of all group members that meet the user's selection criteria.

It will be appreciated that the user selections just described may be made in a different order, or some of the selections, e.g., institution names, may not be made at all, as long as the final search output of professionals with the sought expertise represents and manageable amount of search information for the user.

G. Statement Searching for Professional Expertise

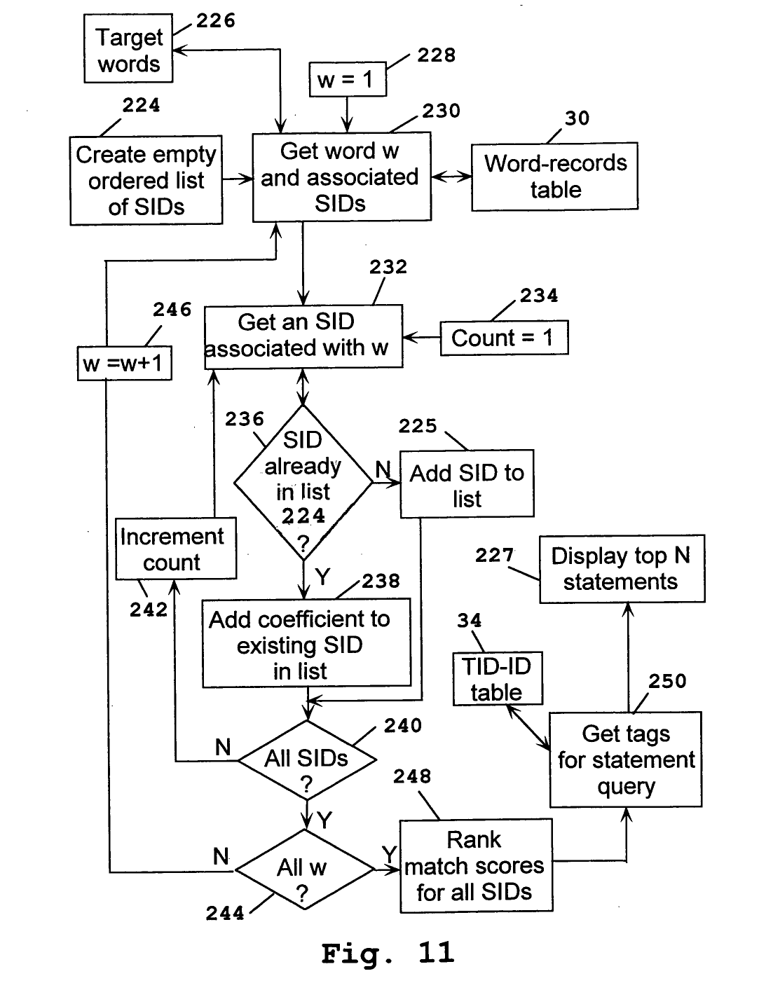

This section considers the operation of the system in finding one or more tagged statements and associated tags in response to a user input query composed of word, and optionally, word-group terms that describe or are descriptive of the given problem or specialty for which expertise is being sought. As will be appreciated from the search procedures described below, the input query represents a content-rich shorthand to the subject matter, providing a high-content “hook” to a tagged statement. Further, since the statement is typically a short, pithy summary of an idea of interest, there will usually be a high word overlap between the query statement and statement sought to be retrieved. The operation of the search engine will be described below with reference to FIG. 11.

Once a group of ranked statements is returned in the search, and the user has selected one or more of these statements as pertinent, the program identifies associated tags and links these tags to group-member professionals, as will be described below with reference to FIG. 12.

Individual statements are identified and selected, in accordance with one aspect of the invention, by the user entering a word query that represents or is representative of the problem or specialty of interest, i.e., a description of the legal problem faced by the user, such as: (i) “rules governing the trading of commodities on the internet, and applying for a trading license with the Commodity Futures Trading Commission” or (ii) “state court litigation involving misappropriation of computer trade secrets.” In looking for a medical professional, the problem-of-interest query might be (i) optimal drug treatment of ovarian cancer and expected five-year survival rates, or (ii) treatment of depression in elderly patients with Alzheimer's disease.”

The system then searches the database and returns statements that have the closest (highest-ranking) word match with that query, along with pertinent citation tags associated with the statements. As a first step in the search, the program converts the user query, which can include either a user-input statement or a user-selected statement into a search vector. The search vector may be composed of word and optionally word-pair terms, and for each term, a coefficient that indicates the weight that term is to be given, relative to other terms in the vector. In one embodiment, the vector terms are simply all of the non-generic words contained in the paragraph summary, with each word being assigned a coefficient value of 1. In this embodiment, the program simply reads the paragraph summary, extracts non-generic words, converts verb words to verb-root words, and assigns each term a coefficient of 1. If a more refined search is desired, the program may operate to extract both non-generic words and proximately formed word pairs in constructing the search vector, and assign to these terms either the same coefficient, e.g., 1, or a coefficient related to the term's selectivity value and optionally, inverse document frequency (IDF) (in the case of word terms), as described in co-owned fully in co-owned published PCT patent application for “Text-Representation, Text Matching, and Text Classification Code, System, and Method,” having International PCT Publication Number WO 2004/006124 A2, published on Jan. 14, 2004, which is incorporated herein by reference in its entirety and referred to below as “co-owned PCT application.”

Although not shown here, the vector may be modified to include synonyms for one or more “base” words in the vector. These synonyms may be drawn, for example, from a dictionary of verb and verb-root synonyms such as discussed above. Here the vector coefficients are unchanged, but one or more of the base word terms may contain multiple words, again as described in the above co-owned PCT patent application.

As indicated above, the search operates to find the statements in the system having the greatest term overlap with the target search vector terms. Briefly, and with reference to FIG. 11, an empty ordered list of SIDs, shown at 224, stores the accumulating match-score values for each SID associated with the vector terms. The program initializes the vector term (e.g., word) at w=1 (box 228) and retrieves (box 230) the first word and associated coefficient from target words 226 and retrieves all of the SIDs associated with that word from word-records table 30. With the SID count set to 1 (box 234), the program gets an SID associated with word w (box 232). With each SID that is considered, the program asks, at 236: Is the SID already present in list 200? If it is not, the SID and the term coefficient for word w are added to list 224, creating the first coefficient of the summed coefficients for that SID. (For the first word of the search vector (w=1), each SID will be newly added to the list.). If the SID is in list 224, the program adds the word coefficient to the existing SID in the list, at 238. This procedure is repeated, through the logic of 240 and 242 until all SIDs for word w have been considered and added to list 200. The program then advances to the next search word, through the logic of 244, 246, and the process is repeated for all SIDs associated with that word.

When all of the words in the search vector have been considered (box 244), the program adds the coefficient scores for each SID, and ranks the SIDs by match score, at 248. By accessing tag-ID table 34, the program gets all citation tags for the top N statements, for example, all statements whose match score is at least 75% of a perfect match score, and also displays these statements to the user, at 227, along with the accompanying tag. Typically, the user will review the statements and select one or more that capture the meaning of the search query, yielding at 250 a list of citation tags corresponding to the statements selected by the user as closest in meaning to the search query.

The Example below illustrates two search queries for statements and associated citations, in accordance with this embodiment of the invention. The results indicate the type and number of closely matching statements that can be expected in the search. The results also provide a sampling of other statements associated with two of the citations, to illustrate the type and variation of statements associated with a typical citation.

Once tagged statements are retrieved and selected by the user, and the corresponding citation tags identified, at 250 in FIG. 12, the program accesses group-ID table 36 to identify each of the TIDS in that table corresponding to the TIDs identified from the statement search at 250. For each TID in table 36, the program extracts all of the MIDs and associated information at 252, and culls this list at 254, to preserve only those MIDs whose group-member data matches the user specialty, locales, type and or/name selections stored at 225 (from FIG. 10).

Typically, the program is set to retrieve at least N group-member names and associated data in response to a user search, where N may be selected to be as few as 1 or as many as 10 or more. If N names are found, these are ranked, e.g., by statement-match score, and displayed along with pertinent group-member information, such as the group member's specialty, institution, contact information and the identity of the article or brief containing the tag or tags used to identify that group member.

If fewer than N names are found, again at 256 in FIG. 12, either because the tags identified in the search are not associated with a sufficient number of group-member names, or because the group-member constraints imposed initially by the user are too restrictive, the program may use the tag co-occurrence matrix described above to expand the group of “statement-related” tags. This is done, is indicated at 260 in FIG. 12, by accessing the tag co-occurrence 38 to identify for each “direct” tag from the statement query at 250, an “indirect” tag having the highest co-occurrence value with respect to the direct tag. The indirect tags are then processed through the steps indicated in FIG. 12, to identify additional group members who are linked to one or more of the indirect tags. If, at step 256, the total number of group members identified in the search is still fewer than N, the procedure is repeated for the tags having the next-highest co-occurrence values with respect to the direct tags, and so forth, until N names can be displayed to the user.

From the forgoing, it will be appreciated how various objects and features of the invention are met. The method allows a prospective client or patient to identify a professional with a selected expertise, based on that professional's own writings, as proof of professional competence. The method also allows professionals to directly market themselves and their expertise to prospective clients or patients on a website in a neutral, unbiased forum. Thus, in one preferred embodiment, the search is hosted on a neutral website, such as a website that supports other types of legal and/or technical searching, to allow users to identify qualified professionals without having to first access institution or organization sites that are designed in part to promote their own professionals.

The following example illustrates, but in no way is intended to limit, certain methods of the invention.

### EXAMPLE

### Word Query Searches for Statements and Citations

Approximately 1,000 recent decisions from the Court of Appeals for the Federal Circuit (CAFC) involving questions of patent law were processed to extract all citations and associated statements. The extracted statements and citations were assembled into a database having a word index table, a statement-ID table, and a citations-ID as described above.

A. Citation search 1: The statement query in a first search was: “claims are interpreted on the basis of intrinsic evidence, that is, the claim language, the written description, and the prosecution history.”

The program was set to display the top 15 statement word matches. As a sample of the quality of word matches, the retrieved statements that were ranked 1, 4, 7, 10, and 13 are presented below, along with the associated citation and the number of documents containing that citation:

1. “the words used in the claim[ ] are interpreted in light of the intrinsic evidence of record, including the written description, the drawings, and the prosecution history, if in evidence.” teleflex, inc. v. ficosa n. am. corp., 299 f.3d 1313, 211 f.3d 1367. 53 docs contain this cite.

4. “in determining the meaning of disputed claim language, we look first to the intrinsic evidence of record, examining the claim language itself, the specification, and the prosecution history.” interactive gift express, inc. v. compuserve, inc., 256 f.3d 1323. 31 docs contain this cite.

7. “as a basic principle of claim interpretation, prosecution disclaimer promotes the public notice function of the intrinsic evidence and protects the public's reliance on definitive statements made during prosecution.” digital biometrics v. identix, inc., 149 f.3d 1335. 8 docs contain this cite.

10. “indeed, claims are not construed in a vacuum, but rather in the context of the intrinsic evidence, viz., the other claims, the specification, and the prosecution history.” demarini sports, inc. v. worth, 239 f.3d 1314.13 docs contain this cite.

13. “as a basic principle of claim interpretation, prosecution disclaimer promotes the public notice function of the intrinsic evidence and protects the public's reliance on definitive statements made during prosecution.” omega eng'g, inc. v. raytek corp., 334 f.3d 1314. 32 docs contain this cite.

As seen, each of the statements from the documents, at least down through the 13^{th} ranked statement, shows a good content match with the user query. For each citation, the total number of statements associated with that citation was typically equal to the number of documents containing that cite. Thus, for example, in the citation for the 10^{th}-ranked statement: digital biometrics v. identix, inc., 149 f.3d 1335. a total of eight documents contained this citation.

The eight statements associated with this citation were:

1. as a basic principle of claim interpretation, prosecution disclaimer promotes the public notice function of the intrinsic evidence and protects the public's reliance on definitive statements made during prosecution.

2. as a basic principle of claim interpretation, prosecution disclaimer promotes the public notice function of the intrinsic evidence and protects the public's reliance on definitive statements made during prosecution.

3. a disclaimer must be clear and unambiguous.

4. statements that describe the invention as a whole, rather than statements that describe only preferred embodiments, are more likely to support a limiting definition of a claim term.

5. id.

6. and therefore consideration of extrinsic evidence is inappropriate.

7. such as expert testimony and treatises, is improper.

8. when the court relies on extrinsic evidence to assist with claim construction, and the claim is susceptible to both a broader and a narrower meaning, the narrower meaning should be chosen if it is supported by the intrinsic evidence.

This sample of statements illustrates the type and variation of statements that might be expected for a given citation tag.

A. Citation search 2: The statement query in a second search was: “whether the doctrine of equivalents can be used to recapture claim scope surrendered during patent acquisition is a question of law.”

As above, the program was set to display the top 15 statement word matches, and the statements that were ranked 1, 3, 7, 10, and 13 are displayed, including the corresponding citation and number of documents containing that citation:

1. “application of the rule precluding use of the doctrine of equivalents to recapture claim scope surrendered during patent acquisition is a question of law.” kcj corp. v. kinetic concepts, inc., 223 f.3d 1351. 5 docs contain this cite.

3. “application of prosecution history estoppel to limit the doctrine of equivalents presents a question of law that this court reviews without deference.” glaxo wellcome, inc. v. impax labs., inc., 356 f.3d 1348. 3 docs contain this cite.

7. “prosecution history estoppel as a limit on the doctrine of equivalents presents a question of law.” wang labs., inc. v. mitsubishi elecs. am., inc., 103 f.3d 1571.4 docs contain this cite.

10. “a patent applicant may limit the scope of any equivalents of the invention by statements in the specification that disclaim coverage of subject matter.” j m corp. v. harley-davidson, inc., 269 f.3d 1360. 3 docs contain this cite.

13. “the district court's determination that chicago brand's complaint was barred under ninth circuit law by the doctrine of res judicata is a mixed question of law and fact, wherein legal issues predominate.” gregory v. widnall, 153 f.3d. 071. 1 doc contains this cite.

As can be seen, content match with the user query dropped off significantly between the 7th and 10th ranked statements, indicating a more limited number of citations that contain the statement of interest.

The 1^{st} ranked citation, kcj corp. v. kinetic concepts, inc., 223 f.3d 1351, was found in five documents, and was associated with a total of five statements. These statements, given below, further illustrate the type and variation in statements that can be expected for a given citation.

1. “application of the rule precluding use of the doctrine of equivalents to recapture claim scope surrendered during patent acquisition is a question of law.”

2. “creates a presumption that the recited elements are only a part of the device, that the claim does not exclude additional, unrecited elements.”

3. “in open-ended claims containing the transitional statement “comprising.”

4. “asserted claims 1 and 6 recite a list of lewis aTID inhibitors presented in the form of a markush group.”

5. “such references are not enough to limit the claims to a unitary structure.

While the invention has been described with respect to particular embodiments and applications, it will be appreciated that various changes and modification may be made without departing from the spirit of the invention.

It is claimed:

1. A computer-assisted method for identifying, from among a group of professionals, one or more professionals having expertise with a given problem or specialty of interest, comprising
(a) processing a user-input query composed of word, and optionally, word-group terms that are descriptive of the given problem or specialty for which expertise is being sought,
(b) accessing a database containing a word record of summary statements that include holdings, principles, conclusions, or definitions taken from a library of citation-rich documents in the field of the professional, to identify one or more summary statements having high term matches with the user-input query,
(c) accessing a database containing citation tags linked to the summary statements, where the tags represent citations assigned to said statements in citation-rich documents, to identify one or more one or more tags linked to the statement(s) identified in step (b),
(d) accessing a database containing group-member identifiers linked to citation tags, through citation tags taken from citation-rich documents prepared by members of the group of professionals, to identify one or more group members linked to the one or more tags identified in step (c), and
(e) presenting the group-member identifier(s) identified in step (c) to the user.

2. The method of claim 1, wherein said processing in step (a) includes constructing a search vector composed of non-generic word, and optionally, word-group terms, and term-value coefficients assigned to each term, and said accessing step (b) is effective to identify summary statements having the top match score with the search vector.

3. The method of claim 2, which further includes, as part of step (b) presenting identified summary statements to the user, and having the user select those statements which best represent the problem or specialty for which expertise is being sought.

4. The method of claim 1, wherein the database accessed in each of steps (b)-(c) is part of a single relational database.

5. The method of claim 1, wherein the citation-rich documents prepared by members of the group of professionals, and from which are extracted citation tags that link members of the group to specific tags, and the library of citation-rich documents from which the summary statements and associated tags are extracted, are substantially different sets of citation-rich documents.

6. The method of claim 5, for use in identifying one or more legal professionals having expertise with a given legal problem of interest, wherein the citations tags linked to group-member identifiers are taken from citation-rich documents authored by one or more group members, and include documents selected from law-journal articles and court briefs, and said summary statements and associated tags are taken from a library of citation-rich documents that include appellate court decisions.

7. The method of claim 5, for use in identifying one or more medical professionals having expertise with a given medical problem of interest, wherein the citation tags linked to group-member identifiers are taken from citation-rich documents authored by one or more group members, and include medical journal articles, and said summary statements and associated tags are taken from a library of citation-rich documents that include medical journal articles.

8. The method of claim 1, wherein the citation-rich documents prepared by members of the group of professionals, and from which are extracted citation tags that link members of the group to specific tags, and the library of citation-rich documents from which the summary statements are extracted, are substantially the same set of citation-rich documents.

9. The method of claim 1, wherein the identifier of each group member includes the member's name, professional specialty, locale, type of organization, and name of organization, the user input query includes constraints on one or more of group-member specialty, locale, organization type, and organization name, and step (d) is carried out to identify at least one group-member tag that also matches the user-input constraints.

10. The method of claim 1, wherein said database accessed in step (c) includes a matrix whose matrix values represent, for each pair of citation tags, a co-occurrence value related to the document co-occurrence of the two tags of the pair in the citation-rich documents from which the tags were taken, and step (c) includes accessing the database to identify one or more one or more tags linked directly to the statement(s) identified in step (b), or linked indirectly to the statement(s) identified in (b) through an above-threshold co-occurrence linkage to a tag directly linked to such statement(s).

11. For use in identifying, among a group of professionals, one or more professionals having expertise with a given problem or specialty of interest, machine-readable code which is operable on a computer to execute machine-readable instructions for performing the steps comprising
(a) processing a user-input query composed of word, and optionally, word-group terms that together represent or are representative of the given problem or specialty for which expertise is being sought,
(b) accessing a database containing a word record of summary statements, including holdings, principles, conclusions, or definitions contained in a library of citation-rich documents in the field of the professional, to identify one or more summary statements having high term matches with the user-input query,
(c) accessing a database containing citation tags linked to the summary statements, where the tags represent citations assigned to said statements in citation-rich documents, to identify one or more one or more tags linked to the statement(s) identified in step (b),
(d) accessing a database containing group-member identifiers linked to citation tags, through citation tags taken from citation-rich documents prepared by members of the group of professionals, to identify one or more group members linked to the one or more tags identified in step (c), and
(e) presenting the group-member identifier(s) identified in step (c) to the user.

12. The machine-readable code of claim 11, wherein the databases accessed are part of a single relational database.

13. A relational database for use in identifying, among a group of professionals, one or more professionals having expertise with a given problem or specialty of interest, comprising database tables containing:
(i) a word record of summary statements, including holdings, principles, conclusions or definitions contained in a library of citation-rich documents in the field of the professional,
(ii) citation tags linked to the summary statements, where the tags represent citations assigned to said statements in citation-rich documents, and
(iii) group-member identifiers linked to citation tags, through citation tags taken from citation-rich documents prepared by members of the group of professionals.

14. The database of claim 13, wherein the citation-rich documents prepared by members of the group of professionals, and from which are extracted citation tags that link members of the group to specific tags, and the citation-rich documents from which the summary statements are extracted, are two substantially different sets of citation-rich documents.

15. The database of claim 13, wherein the citation-rich documents prepared by members of the group of professionals, and from which are extracted citation tags that link members of the group to specific tags, and the citation-rich documents from which the summary statements are extracted, are substantially the same set of citation-rich documents.

16. The database of claim 13, which includes a matrix whose matrix values represent, for each pair of citation tags, a co-occurrence value related to the document co-occurrence of the two tags of the pair in the citation-rich documents from which the tags were taken.
